(19) United States
(12) Patent Application Publication
(10) Pub. No.: US 2026/0292596 A1
(43) Pub. Date: Sep. 24, 2026

(54) ENHANCED ENERGY EFFICIENCY INFORMATION FOR NETWORK ENERGY SAVING

(71) Applicant: Nokia Technologies Oy, Espoo (FI)

(72) Inventors: Daniela LASELVA, Aalborg (DK); Frank FREDERIKSEN, Aalborg (DK); Anna PANTELIDOU, Massy (FR)

(21) Appl. No.: 19/100,639

(22) PCT Filed: Aug. 8, 2022
(86) PCT No.: PCT/US2022/039741

§ 371 Date: Feb. 3, 2025

(51) Int. Cl. H04W 28/08; H04W 24/10; H04W 52/02

(52) U.S. Cl. CPC H04W 28/0917; H04W 24/10; H04W 52/0203

(57) ABSTRACT

Systems, methods, apparatuses, and computer program products for enhanced energy efficiency information and the distribution and reception thereof for network energy saving are provided. For example, a method can include identifying multiple own cell capabilities that include an own cell capability to carry extra load with no extra energy consumption, an own cell capability to carry extra load with extra energy consumption, and an own cell capability to reduce load with an energy saving gain. The method can also include indicating to a neighboring radio access network node or an operations and maintenance function energy cost for extra load and energy saving for removed load based on the own cell capabilities. The method can further include receiving onloading of cell traffic or offloading of cell traffic, based on the indication of the energy cost for extra load and the energy saving for removed load.

### FIELD

Some example embodiments may generally relate to communications including mobile or wireless telecommunication systems, such as Long Term Evolution (LTE) or fifth generation (5G) radio access technology or new radio (NR) access technology, or other communications systems including subsequent generations of the same or similar standards. For example, certain example embodiments may generally relate to enhanced energy efficiency information and the distribution and reception thereof for network energy saving.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also be built on the E-UTRA radio. From release 18 (Rel-18) onward, 5G is referred to as 5G advanced. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 6G is currently under development and may replace 5G and 5G advanced.

### SUMMARY

An embodiment may be directed to an apparatus. The apparatus can include at least one processor and at least memory including computer program. The at least one memory and the computer program can be configured to, with the at least one processor, cause the apparatus at least to identify own cell capability comprising at least one of an own cell capability to carry extra load with no extra energy consumption, an own cell capability to carry extra load with extra energy consumption, or an own cell capability to reduce load with an energy saving gain. The at least one memory and the computer program can also be configured to, with the at least one processor, cause the apparatus at least to indicate to a neighboring radio access network node or an operations and maintenance function at least one of energy cost for extra load or energy saving for removed load based on the own cell capability. The at least one memory and the computer program can further be configured to, with the at least one processor, cause the apparatus at least to receive onloading of cell traffic or offloading of cell traffic, based on the indication of the at least one of the energy cost for extra load or the energy saving for removed load.

An embodiment may be directed to an apparatus. The apparatus can include at least one processor and at least memory including computer program. The at least one memory and the computer program can be configured to, with the at least one processor, cause the apparatus at least to receive, from a neighboring radio access network node or an operations and maintenance function, indication of at least one of energy cost for extra load or energy saving for removed load based on cell capability of the neighboring radio access network node. The at least one memory and the computer program can also be configured to, with the at least one processor, cause the apparatus at least to determining to perform onloading of cell traffic to or offloading of cell traffic from the neighboring radio access network, based on the indication of the at least one of the energy cost for extra load or the energy saving for removed load. The at least one memory and the computer program can further be configured to, with the at least one processor, cause the apparatus at least to handling cell traffic based on the determination.

An embodiment may be directed to a method. The method can include identifying own cell capability comprising at least one of an own cell capability to carry extra load with no extra energy consumption, an own cell capability to carry extra load with extra energy consumption, or an own cell capability to reduce load with an energy saving gain. The method can also include indicating to a neighboring radio access network node or an operations and maintenance function at least one of energy cost for extra load or energy saving for removed load based on the own cell capability. The method can further include receiving onloading of cell traffic or offloading of cell traffic, based on the indication of the at least one of the energy cost for extra load or the energy saving for removed load.

An embodiment may be directed to a method. The method can include receiving, from a neighboring radio access network node or an operations and maintenance function, indication of at least one of energy cost for extra load or energy saving for removed load based on cell capability of the neighboring radio access network node. The method can also include determining to perform onloading of cell traffic to or offloading of cell traffic from the neighboring radio access network, based on the indication of the at least one of the energy cost for extra load or the energy saving for removed load. The method can further include handling cell traffic based on the determination.

An embodiment can be directed to an apparatus. The apparatus can include means for identifying own cell capability comprising at least one of an own cell capability to carry extra load with no extra energy consumption, an own cell capability to carry extra load with extra energy consumption, or an own cell capability to reduce load with an energy saving gain. The apparatus can also include means for indicating to a neighboring radio access network node or an operations and maintenance function at least one of energy cost for extra load or energy saving for removed load based on the own cell capability. The apparatus can further include means for receiving onloading of cell traffic or offloading of cell traffic, based on the indication of the at least one of the energy cost for extra load or the energy saving for removed load.

An embodiment can be directed to an apparatus. The apparatus can include means for means for receiving, from a neighboring radio access network node or an operations and maintenance function, indication of at least one of energy cost for extra load or energy saving for removed load based on cell capability of the neighboring radio access network node. The apparatus can also include means for determining to perform onloading of cell traffic to or offloading of cell traffic from the neighboring radio access network, based on the indication of the at least one of the energy cost for extra load or the energy saving for removed load. The apparatus can further include means for handling cell traffic based on the determination.

### BRIEF DESCRIPTION OF THE DRAWINGS

For proper understanding of example embodiments, reference should be made to the accompanying drawings, wherein:

FIG. 1 illustrates energy efficiency as a function of daily data volume;

FIG. 2 illustrates a signal flow diagram for a case of exchange of energy efficiency information between radio access network nodes, according to certain embodiments;

FIG. 3 illustrates a signal flow diagram for a case of exchange of energy efficiency information between radio access network nodes in a central unit and distributed unit split architecture, according to certain embodiments;

FIG. 4 illustrates a signal flow diagram for a case of exchange of energy efficiency information between a radio access network node and operations and maintenance function, according to certain embodiments;

FIG. 5 illustrates a simplified diagram of the relationship between potential energy efficiency and data volume that a radio access node can construct to derive energy efficiency information, according to certain embodiments;

FIG. 6A illustrates a method according to certain embodiments;

FIG. 6B illustrates a method according to certain embodiments; and

FIG. 7 illustrates an example block diagram of a system, according to an embodiment.

### DETAILED DESCRIPTION:

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing enhanced energy efficiency information and the distribution and reception thereof for network energy saving, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain embodiments relate to enhancements for network energy savings in fifth generation (5G) communication systems. Reducing the energy consumption of mobile networks, and particularly of the RAN, which consumes the largest part of the total energy consumption in the network, may be beneficial.

Artificial intelligence (AI) and/or machine leaning (ML) may be used in a radio access network (RAN) to provide energy saving. The ML may benefit from being configured to provide suitable outputs and receive suitable inputs. Various aspects of network architecture, including various interfaces, may be used to support the reception of such inputs and distributions of such outputs.

For example, for an AI/ML-based network energy saving attempt there may be input information from a local RAN node, input from a user equipment (UE), and input from neighboring next generation RAN (NG-RAN) nodes. The input from NG-RAN nodes can include current/predicted energy efficiency, current/predicted resource status, and current energy state, which can be active, high, low, or inactive. Other inputs are described in the third generation partnership project (3GPP) technical report (TR) 37.817.

The radio network may consider energy savings with respect to adaptation techniques of transmissions and/or receptions in time, frequency, spatial, and power domains, with potential support and/or feedback from UE, such as UE assistance information, and information exchange/coordination over network interfaces, such as interfaces between UE and RAN.

Currently, network energy saving can be achieved using approaches that can include infrequent synchronization signal Block (SSB) transmission, for example SSB periodicity of 160 ms, which could be considered in empty/low load situation in 5G non-standalone (NSA) deployments. The approaches can also include micro discontinuous transmission (DTX), which can involve shutting down a power amplifier on a per orthogonal frequency division multiplexing (OFDM) symbol basis, in symbols that do not carry data or signaling. Other approaches can include, based on network architecture and capability, shutting down further components, such as transmit antennas as in massive multiple input multiple output (mMIMO) muting and/or baseband circuity. Furthermore, other approaches can include total cell switch off or cell shutdown, which may allow switching off one or more cells, for example at a given frequency layer, and hence switch off most of the hardware components of the corresponding radio unit and/or RAN site.

Some energy efficiency (EE) metrics, such as data volume over energy consumption, gigabytes per kilowatt-hour (GB/kWh) or megabytes per watt (MB/W), may not reflect the cell load nor the energy consumption used to support more or less load. Therefore, those metrics may have limited use in deciding whether it is beneficial to offload a UE to a neighbor cell or not from an energy consumption perspective. For example, load balancing schemes may try to move traffic towards the most energy efficient cell.

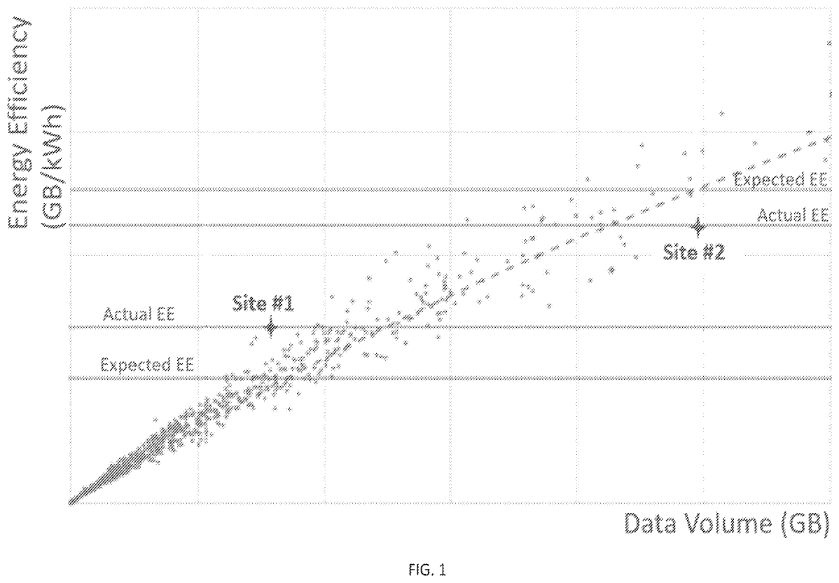

FIG. 1 illustrates energy efficiency as a function of daily data volume. In FIG. 1, energy efficiency is expressed in GB/KWH and daily data volume is shown in gigabytes. In FIG. 1, each point represents a different site. Based on the example values of FIG. 1, traffic would be offloaded to Site B, because Site B has a higher EE than Site A. On the other hand, moving traffic to site A may be more beneficial as Site A's EE is low only because of low traffic, rather than low energy efficiency. In fact, in the example Site A is a new and modernized site, while Site B is an older site with older HW equipment and thus poorer energy efficiency.

Certain embodiments address the shortcoming that the EE may only be known for the given amount of data volume, but the behavior of the EE curve is unknown for the case of adding or subtracting traffic. The effects of delta traffic may not need to be the same for two gNBs that have the same EE since the effects may depend on the gNBs' capability, load, and other energy saving actions that the gNBs can employ.

Certain embodiments determine and provide energy efficiency (EE) information related to the energy saving or cost associated with adding or removing extra traffic, for example GB/Mbps, from a set of cells/gNBs. Such information can be expressed in terms of energy cost for extra load, for example energy cost per gigabyte, and energy saving for removed load, for example energy savings per gigabyte. Such energy efficiency information can be exchanged between neighbor gNB nodes or between O&M and gNB nodes can aid the energy saving decisions/policies, for example regarding onloading/offloading traffic.

In one example, a gNB node may indicate, to a neighboring gNB or to an operations and maintenance (O&M or OAM) function, the capability or capacity of a cell of the gNB to carry extra load, for example an extra X GB/Mbps, with no extra additional energy consumption. This extra capacity may be because the gNB can utilize all the unused bandwidth in the cell without the need to switch on further hardware. For example, no additional power amplifier (PA) system on chip (SoC), radio frequency interface (RFIC) or fan may be needed.

In a further example, a gNB node may indicate, to a neighboring gNB or to an OAM function, the capability or capacity of a cell of the gNB to carry extra load, such as an additional X GB/Mbps, with extra additional energy consumption, for example x KWh. The extra energy consumption may be useful because the gNB may need to switch on further hardware, for example an extra PA/SoC/RFIC/fan, or increase the power consumption of certain hardware elements, such as increasing the fan speed, increasing the processor clock speed of a central processing unit (CPU), or the like. The indication from the gNB node can be triggered by a request from a neighbouring gNB.

In one example, the capacity cell sends this information to OAM so that OAM decides the best policy, as to whether to offload or onload traffic to the given cell.

In one example, a gNB node may indicate, to a neighboring gNB or to an OAM function, the capability or capacity of a cell of the gNB to reduce the load, for example by Y GB/Mbps, with an energy saving gain of y%. In one example, the capacity cell can send this information to OAM so that OAM decides the best policy as to whether to offload traffic from the given cell. In one example, the coverage cell can provide this information with the aim to reduce traffic whenever possible. Thus, the indication from the gNB node can be triggered by a request from a neighbouring gNB.

In one example, multiple energy saving values and/or multiple energy cost values per GB/megabits per second (Mbps) can be provided at different increase/decrease of data volume, for example different amounts of GB or different data rates, for example different Mbps values.

Although each value can be associated with a given set of hardware components to be ON/OFF or activated/deactivated, in light of the associated energy saving techniques to be applied, the provided information may not provide such details. Instead the provided information may indicate whether adding or removing traffic is energy outcome beneficial, and by how much. Thus, the information may be provided for power saving purposes rather than for explaining how the energy saving is achieved. There may be no need to expose to the neighboring nodes the actual ES strategies that may be employed. For example, the gNB may not need to indicate whether the power is saved or spent in any particular way: for example time domain at slot/symbol/radio frame level, frequency domain at physical resource block (PRB), bandwidth part (BWP), carrier level, or space domain at, for example beam level. Even when more particularity is provided, the exact mechanisms for power savings or expenditure may not need to be revealed.

In one additional example, there may be an AI/ML aspect. The estimated energy cost or energy saving per given load, for example per GB, can be determined, and such EE information can be exchanged between neighbor gNBs or can be sent from a gNB to OAM in advance. Since a capacity cell may need to prepare for a cell switch off early enough, a neighboring gNB may only be able to provide such expected cost to carry the additional X load at the expected time of the switch off. Accordingly, the actual cost or actual energy saving can be provided in terms of feedback information after an offloading action is taken and a UE or a group of UEs is offloaded to the node. The group may correspond to a slice, cell region or UEs satisfying a certain condition, for example UEs whose measured RSRP values belong in a certain range, UEs that are offloaded from a certain cell to given other cell, and the like.

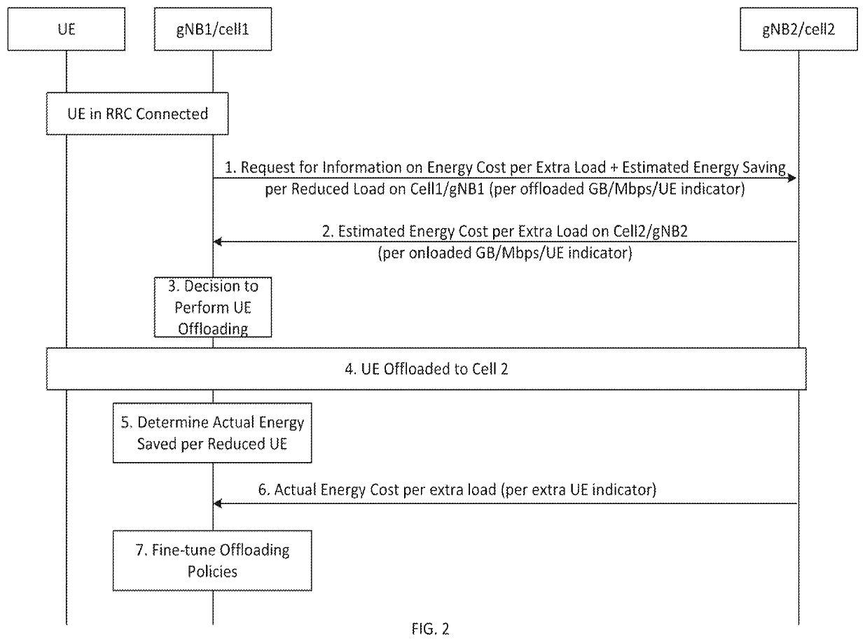

FIG. 2 illustrates a signal flow diagram for a case of exchange of energy efficiency information between radio access network nodes, according to certain embodiments. More particularly, FIG. 2 illustrates EE information being exchanged between neighbor gNBs. This approach can be viewed as inter-gNB exchange of proposed EE information.

As shown in FIG. 2, a UE may be in radio resource control (RRC) connected mode with a first cell, gNB1/cell1. The first cell may, at 1, request information from a second cell, gNB2/cell2, on energy cost per extra load for the second cell and may provide estimated energy saving per reduced load on the first cell. The information may be per offloaded/onloaded GB, Mbps, and/or UE, UE Type, or group of UEs. The second cell may, at 2, respond with estimated energy cost per extra load on the second cell. The information may be per onloaded GB, Mbps, and or UE, UE type or group of UEs.

At 3, the first cell may make a decision to perform offloading. Accordingly, at 4, the UE may be offloaded to the second cell. The first cell may then determine the actual energy saved per offloaded UE. Moreover, the first cell may receive from the second cell the actual energy cost per extra load, such as per extra UE, at 6. At 7, the first cell may adjust the offloading policies, for example by fine-tuning the policies.

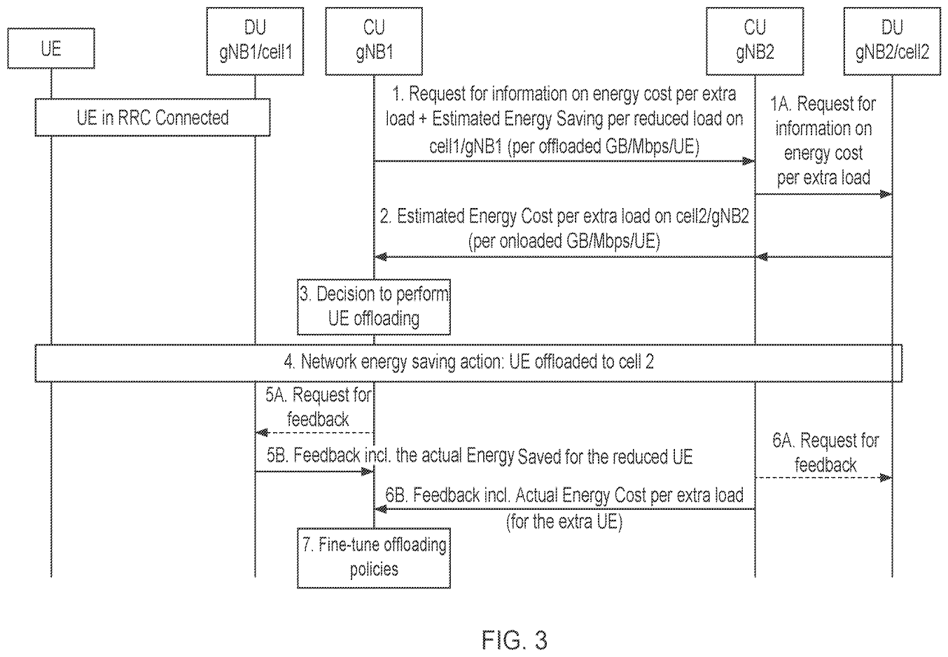

FIG. 3 illustrates a signal flow diagram for a case of exchange of energy efficiency information between radio access network nodes in a central unit (CU)/distributed unit (DU) split architecture, according to certain embodiments. A UE may initially be in RRC connected mode with the distributed unit of a first cell. The central unit of the first cell may send a request for information on energy cost per extra load and provide estimated energy savings per reduced load, at 1. At 1A, the CU of the second cell, having received the request, may send a request for information to the distributed unit of the second cell. The request may be sent to more than one candidate cell where a given UE could be offloaded. In one example, a CU may need to calculate a probability with which a given cell is a candidate for offloading of traffic. It can subsequently send the request to the cells that are the most likely to carry the offloaded UE. At 2, the DU of the second cell may provide an estimated energy cost per extra load on the second cell, which may be passed by the CU of the second cell to the CU of the first cell.

At 3, the CU of the first cell may make a decision to perform UE offloading to the most beneficial cell, for example to the cell that has the least energy cost. At 4, therefore, there may be a network energy saving action, namely that the UE is offloaded to the second cell.

At 5A, the CU of the first cell can send a request for feedback to a DU of the first cell. The DU of the first cell can reply with feedback at 5B, including the actual energy saved for the reduced UE. Likewise, in parallel at 6A, the CU of the second cell may send a request for feedback to a DU of the second cell. The DU may provide, and the CU may forward, the feedback including actual energy cost per extra load to the CU of the first cell, at 6B. At 7, the CU of the first cell can adjust offloading policies, for example by fine-tuning.

Thus, the approach of the signaling diagram of FIG. 3 for the case where the EE information is exchanged between neighbor gNBs may be similar to that of FIG. 2, but may assume the CU/DU split architecture.

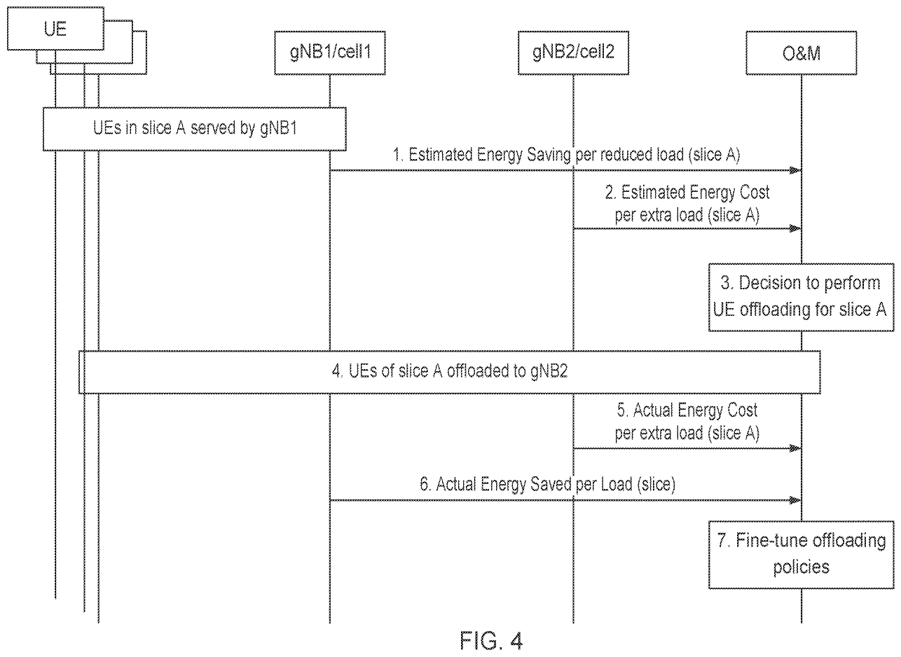

FIG. 4 illustrates a signal flow diagram for a case of exchange of energy efficiency information between a radio access network node and O&M, according to certain embodiments. In FIG. 4, EE information is exchanged between the gNBs and an O&M entity. In this example, the EE information may be associated to a network slice. It could, however, be provided for other UE groups that, for example, fulfil certain conditions, for example UEs whose measured RSRP values belong in a certain range, UEs that are offloaded from a certain cell to given other cell, or the like.

In FIG. 4, UEs in slice A may be served by a first cell, gNB1/cell 1. Although this embodiment does not show a split CU/DU architecture, this approach may be modified as shown above in FIG. 3, as compared with FIG. 2.

At 1 in FIG. 4, the first cell can send an estimated energy saving per reduced load for slice A to the OAM entity. At 2, the second cell may similarly send an estimated energy cost per extra load for slice A to the OAM entity. The first and second cells can also send the opposite information: for example, the first cell can provide information regarding energy cost per extra load and the second cell can provide information regarding energy savings per reduced load, for example with respect to a different slice.

At 3, the OAM entity can make decision to perform UE offloading for a given slice. Thus, at 4, one or more UEs of slice A can be offloaded from the first cell to the second cell. At 5, the second cell can inform the O&M of the actual energy cost per extra load for slice A. Similarly, at 6, the first cell can inform the OAM of the actual energy saved per load in view of the offloaded slice. Finally, at 7, the OAM can adjust, for example by fine-tuning, the offloading policies. In this example, slice could also be replaced with a group of UEs satisfying certain conditions, for example UEs whose measured RSRP values belong in a certain range, UEs that are offloaded from a certain cell to given other cell, to mention a few.

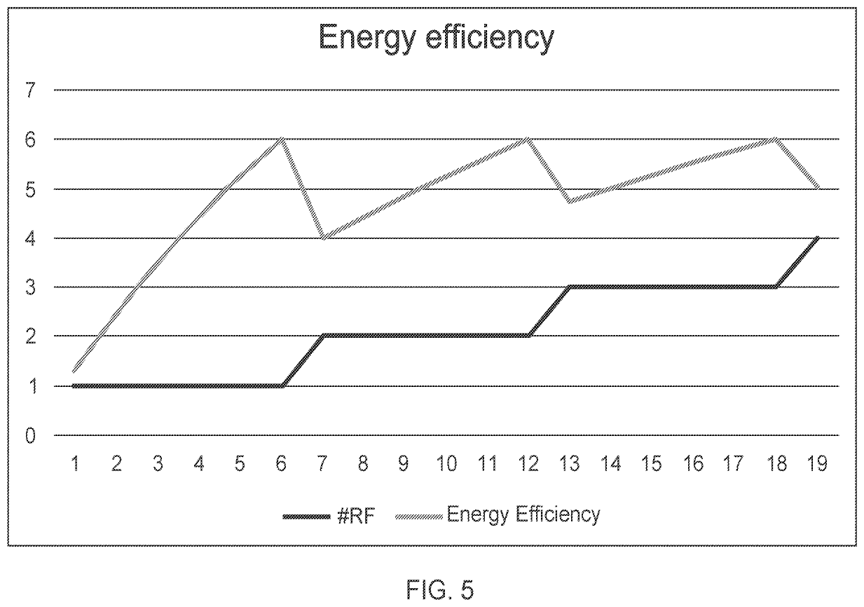

FIG. 5 illustrates a simplified diagram of the relationship between potential EE and data volume that a radio access node, such as a gNB, can construct to derive energy efficiency information, according to certain embodiments. The RAN node or OAM can construct this relationship based on the RAN node's HW architecture and capabilities. The diagram in FIG. 5 takes into account that the EE may increase with an increase of load as long as the increase can be carried with the current HW. There may be a temporary EE drop when further HW activation is needed, until the new HW is fully utilized, when the load can again increase. Many of the HW components may have a static power consumption component and a variable power consumption component that depends on load. The static power consumption, sometimes referred to as digital tax, is to be paid in typical implementation despite no or low traffic. So given that the digital tax is to be paid regardless of the load level, there is no extra energy consumption for fully utilizing the hardware. Such a situation can yield a flat maximum energy efficiency level. The saw-tooth effect can depend on the fact that activating an additional RF chain, which is not fully utilized, can temporarily decrease the energy efficiency as compared to fully utilizing fewer RF chains.

For the illustrated curves in FIG. 5, it may be assumed that one RF chain consumes one unit of power by just switching it on and has the capacity of 6 throughput units. As one RF chain has a capacity of 6 throughput, to increase the capacity above 6, another RF chain needs to be switched on. This next RF chain is also assumed to have a capacity of 6 throughput. FIG. 5 also assumes that going from 0% utilization of hardware to 100% utilization will cost 25% extra power in a linear increase. If the curve for power consumption is not linear, there may also be internal load balancing of the hardware elements to make them further optimized, such as by adjusting three RF chains to 75% utilization rather than two to 100% utilization and one to 25% utilization.

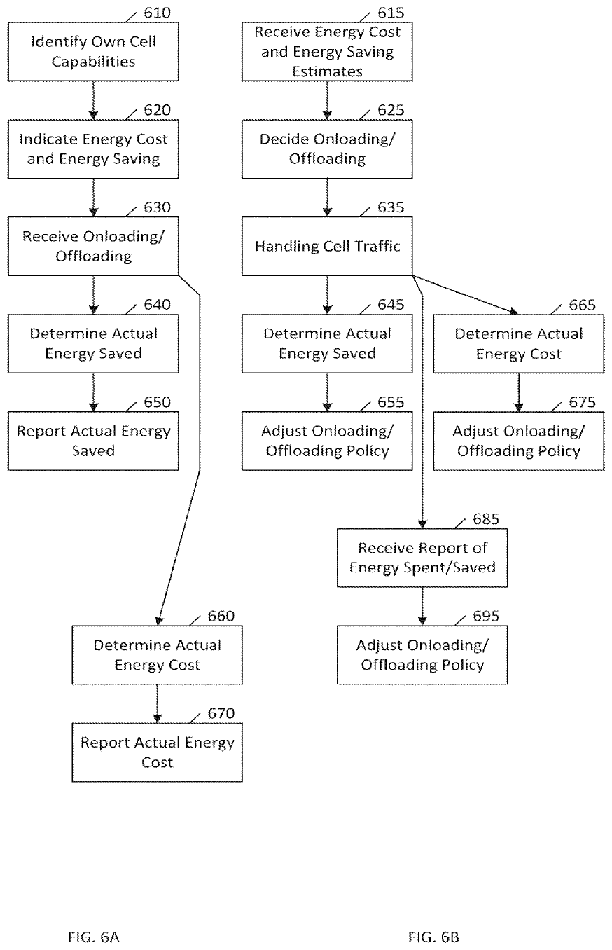

FIG. 6A illustrates a method according to certain embodiments. The method can include, at 610, identifying a plurality of own cell capabilities comprising an own cell capability to carry extra load with no extra energy consumption, an own cell capability to carry extra load with extra energy consumption, and an own cell capability to reduce load with an energy saving gain. The method can also include, at 620, indicating to a neighboring radio access network node or an operations and maintenance function energy cost for extra load and energy saving for removed load based on the plurality of own cell capabilities. The method can further include, at 630, receiving onloading of cell traffic or offloading of cell traffic, based on the indication of the energy cost for extra load and the energy saving for removed load.

The indicating the energy cost for extra load and the energy saving for removed load can include multiple increase values and multiple decrease values. The indicating the energy cost for extra load and the energy saving for removed load can be provided with respect to a specific time.

The method can additionally include, at 640, determining an actual energy saved per reduced user equipment from the offloading of cell traffic. The method can also include, at 650, reporting the actual energy saved to the neighboring radio access network node or the operations and maintenance function.

The method can further include, at 660, determining an actual energy cost per increased user equipment from the onloading of cell traffic. The method can additionally include, at 670, reporting the actual energy cost to the neighboring radio access network node or the operations and maintenance function.

FIG. 6B illustrates a method according to certain embodiments. The method can include, at 615, receiving, from a neighboring radio access network node or an operations and maintenance function, energy cost for extra load and energy saving for removed load based on a plurality of cell capabilities of the neighboring radio access network node. The method can also include, at 625, deciding to perform onloading of cell traffic to or offloading of cell traffic from the neighboring radio access network, based on the indication of the energy cost for extra load and the energy saving for removed load. The method can further include, at 635, handling cell traffic based on the decision.

The indicating the energy cost for extra load and the energy saving for removed load can include multiple increase values and multiple decrease values. The indicating the energy cost for extra load and the energy saving for removed load can be provided with respect to a specific time. For example, the indicating can be for the near future.

The method can include, at 645, determining an actual energy saved per reduced user equipment from the handling of cell traffic. The method can also include, at 655, adjusting an on-loading or off-loading policy based on the actual energy saved. The network, for example a control gNB or OAM, may derive an error or pattern from the reported estimated energy saving or energy cost for a given cell/gNB based on the actual reported values, and then compensate/correct for these errors at least partially for the given cell/gNB.

The method can further include, at 665, determining an actual energy cost per increased user equipment from the handling of cell traffic. The method can additionally include, at 675, adjusting an on-loading or off-loading policy based on the actual energy cost.

The method can also include, at 685, receiving a report from the neighboring radio access network node or the operations and maintenance function of actual energy saved or actual energy cost from the handling of cell traffic. The method can further include, at 695, adjusting an on-loading or off-loading policy based on the report.

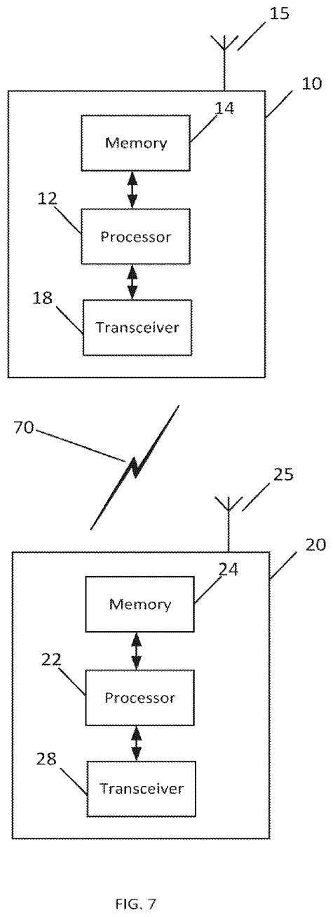

FIG. 7 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be a gNB or other similar radio node, for instance.

It should be understood that, in some example embodiments, apparatus 10 may include an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 7.

As illustrated in the example of FIG. 7, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 7, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to enhanced energy efficiency information and the distribution and reception thereof for network energy saving.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can include any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-6B, or any other method described herein. In some embodiments, as discussed herein, apparatus 10 may be configured to perform a procedure relating to providing enhanced energy efficiency information and the distribution and reception thereof for network energy saving, for example.

FIG. 7 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 7.

As illustrated in the example of FIG. 7, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 7, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can include any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-6B, or any other method described herein. For example, in an embodiment, apparatus 20 may be controlled to perform a process relating to providing enhanced energy efficiency information and the distribution and reception thereof for network energy saving, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may allow the network to acquire useful information with respect to the impact of load level increases and decreases on energy efficiency. Such provision of information may guide energy savings decisions.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium. The term “non-transitory” as used herein, is a limitation of the medium itself (i.e. tangible, not a signal) as opposed to a limitation on data storage persistency (e.g. RAM vs. ROM).

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

PARTIAL GLOSSARY:

BS Base station BWP Bandwidth part EE Energy efficiency ES Energy saving gNB Next generation NB O&M Operation & Maintenance OFDM Orthogonal Frequency Division Multiplexing RAN Radio Access Network PA Power Amplifier PRB Physical Radio Blocks RRC Radio Resource Control protocol RSRP Reference signal Receive Power PCI Physical Cell ID PRACH Physical RACH Random Access Channel RFIC RF Interface QOS Quality of Service SI System Information SIB System Information Block SoC System on Chip SS Synchronization Signal SSB Synchronization Signal Block TX Transceiver RX Receiver UE User Equipment

We claim:

1. An apparatus, comprising:
at least one processor; and
at least one memory storing instructions that, when executed by the at least one processor, cause the apparatus to at least perform identifying own cell capability comprising at least one of an own cell capability to carry extra load with no extra energy consumption, an own cell capability to carry extra load with extra energy consumption, or an own cell capability to reduce load with an energy saving gain;
indicating to a neighboring radio access network node or an operations and maintenance function at least one of energy cost for extra load or energy saving for removed load based on the own cell capability; and
receiving onloading of cell traffic or offloading of cell traffic, based on the indication of the at least one of the energy cost for extra load or the energy saving for removed load.

2. The apparatus of claim 1, wherein the indication of the at least one of the energy cost for extra load or the energy saving for removed load comprises at least one of a plurality of increase values or a plurality of decrease values.

3. The apparatus of claim 1 or claim 2, wherein the energy cost is an actual energy cost or an expected energy cost and the energy saving is an actual energy saving or an expected energy saving.

4. The apparatus of any of claims 1 to 3, wherein the indication of the at least one of the energy cost for extra load or the energy saving for removed load is provided with respect to a timeframe.

5. The apparatus of any of claims 1 to 4, wherein the at least one memory also stores instructions that, when executed by the at least one processor, cause the apparatus to at least perform determining an actual energy saved per reduced user equipment from the offloading of cell traffic; and
reporting the actual energy saved to the neighboring radio access network node or the operations and maintenance function.

6. The apparatus of any of claims 1 to 5, wherein the at least one memory also stores instructions that, when executed by the at least one processor, cause the apparatus to at least perform determining an actual energy cost per increased user equipment from the onloading of cell traffic; and
reporting the actual energy cost to the neighboring radio access network node or the operations and maintenance function.

7. An apparatus, comprising:
at least one processor; and
at least one memory storing instructions that, when executed by the at least one processor, cause the apparatus to at least perform receiving, from a neighboring radio access network node or an operations and maintenance function, indication of at least one of energy cost for extra load or energy saving for removed load based on cell capability of the neighboring radio access network node;
determining to perform onloading of cell traffic to or offloading of cell traffic from the neighboring radio access network, based on the indication of the at least one of the energy cost for extra load or the energy saving for removed load; and
handling cell traffic based on the determination.

8. The apparatus of claim 7, wherein the indication of the at least one of the energy cost for extra load or the energy saving for removed load comprises at least one of a plurality of increase values or a plurality of decrease values.

9. The apparatus of claim 7 or claim 8, wherein the indication of the at least one of the energy cost for extra load or the energy saving for removed load is provided with respect to a timeframe.

10. The apparatus of any one of claims 7 to 9, wherein the at least one memory also stores instructions that, when executed by the at least one processor, cause the apparatus to at least perform determining an actual energy saved per reduced user equipment from the handling cell traffic; and
adjusting at least one of on-loading or off-loading policy based on the actual energy saved.

11. The apparatus of any one of claims 7 to 10, wherein the at least one memory also stores instructions that, when executed by the at least one processor, cause the apparatus to at least perform determining an actual energy cost per increased user equipment from the handling cell traffic; and
adjusting at least one of on-loading or off-loading policy based on the actual energy cost.

12. The apparatus of any one of claims 7 to 11, wherein the at least one memory also stores instructions that, when executed by the at least one processor, cause the apparatus to at least perform receiving a report from the neighboring radio access network node or the operations and maintenance function of at least one of actual energy saved or actual energy cost from the handling cell traffic; and
adjusting at least one of on-loading or off-loading policy based on the report.

13. A method, comprising:
identifying own cell capability comprising at least one of an own cell capability to carry extra load with no extra energy consumption, an own cell capability to carry extra load with extra energy consumption, or an own cell capability to reduce load with an energy saving gain;
indicating to a neighboring radio access network node or an operations and maintenance function at least one of energy cost for extra load or energy saving for removed load based on the own cell capability; and
receiving onloading of cell traffic or offloading of cell traffic, based on the indication of the at least one of the energy cost for extra load or the energy saving for removed load.

14. The method of claim 13, wherein the indication of the at least one of the energy cost for extra load or the energy saving for removed load comprises at least one of a plurality of increase values or a plurality of decrease values.

15. The method of claim 13 or claim 14, wherein the energy cost is an actual energy cost or an expected energy cost and the energy saving is an actual energy saving or an expected energy saving.

16. The method of any of claims 13 to 15, wherein the indication of the at least one of the energy cost for extra load or the energy saving for removed load is provided with respect to a timeframe.

17. The method of any of claims 13 to 16, further comprising:
determining an actual energy saved per reduced user equipment from the offloading of cell traffic; and
reporting the actual energy saved to the neighboring radio access network node or the operations and maintenance function.

18. The method of any of claims 13 to 17, further comprising:
determining an actual energy cost per increased user equipment from the onloading of cell traffic; and
reporting the actual energy cost to the neighboring radio access network node or the operations and maintenance function.

19. A method, comprising:
receiving, from a neighboring radio access network node or an operations and maintenance function, indication of at least one of energy cost for extra load or energy saving for removed load based on cell capability of the neighboring radio access network node;
determining to perform onloading of cell traffic to or offloading of cell traffic from the neighboring radio access network, based on the indication of the at least one of the energy cost for extra load or the energy saving for removed load; and
handling cell traffic based on the determination.

20. The method of claim 19, wherein the indication of the at least one of the energy cost for extra load or the energy saving for removed load comprises at least one of a plurality of increase values or a plurality of decrease values.

21. The method of claim 19 or claim 20, wherein the indication of the at least one of the energy cost for extra load or the energy saving for removed load is provided with respect to a timeframe.

22. The method of any one of claims 19 to 21, further comprising:
determining an actual energy saved per reduced user equipment from the handling cell traffic; and
adjusting at least one of on-loading or off-loading policy based on the actual energy saved.

23. The method of any one of claims 19 to 22, further comprising:
determining an actual energy cost per increased user equipment from the handling cell traffic; and
adjusting at least one of on-loading or off-loading policy based on the actual energy cost.

24. The method of any one of claims 19 to 23, further comprising:
receiving a report from the neighboring radio access network node or the operations and maintenance function of at least one of actual energy saved or actual energy cost from the handling cell traffic; and
adjusting at least one of on-loading or off-loading policy based on the report.

25. An apparatus, comprising:
means for identifying own cell capability comprising at least one of an own cell capability to carry extra load with no extra energy consumption, an own cell capability to carry extra load with extra energy consumption, or an own cell capability to reduce load with an energy saving gain;
means for indicating to a neighboring radio access network node or an operations and maintenance function at least one of energy cost for extra load or energy saving for removed load based on the own cell capability; and
means for receiving onloading of cell traffic or offloading of cell traffic, based on the indication of the at least one of the energy cost for extra load or the energy saving for removed load.

26. The apparatus of claim 25, wherein the indication of the at least one of the energy cost for extra load or the energy saving for removed load comprises at least one of a plurality of increase values or a plurality of decrease values.

27. The apparatus of claim 25 or claim 26, wherein the energy cost is an actual energy cost or an expected energy cost and the energy saving is an actual energy saving or an expected energy saving.

28. The apparatus of any of claims 25 to 27, wherein the indication of the at least one of the energy cost for extra load or the energy saving for removed load is provided with respect to a timeframe.

29. The apparatus of any of claims 25 to 28, further comprising:
means for determining an actual energy saved per reduced user equipment from the offloading of cell traffic; and
means for reporting the actual energy saved to the neighboring radio access network node or the operations and maintenance function.

30. The apparatus of any of claims 25 to 29, further comprising:
means for determining an actual energy cost per increased user equipment from the onloading of cell traffic; and
means for reporting the actual energy cost to the neighboring radio access network node or the operations and maintenance function.

31. An apparatus, comprising:
means for receiving, from a neighboring radio access network node or an operations and maintenance function, indication of at least one of energy cost for extra load or energy saving for removed load based on cell capability of the neighboring radio access network node;
means for determining to perform onloading of cell traffic to or offloading of cell traffic from the neighboring radio access network, based on the indication of the at least one of the energy cost for extra load or the energy saving for removed load; and
means for handling cell traffic based on the determination.

32. The apparatus of claim 31, wherein the indication of the at least one of the energy cost for extra load or the energy saving for removed load comprises at least one of a plurality of increase values or a plurality of decrease values.

33. The apparatus of claim 31 or claim 32, wherein the indication of the at least one of the energy cost for extra load or the energy saving for removed load is provided with respect to a timeframe.

34. The apparatus of any one of claims 31 to 33, further comprising:
means for determining an actual energy saved per reduced user equipment from the handling cell traffic; and
means for adjusting at least one of on-loading or off-loading policy based on the actual energy saved.

35. The apparatus of any one of claims 31 to 34, further comprising:
means for determining an actual energy cost per increased user equipment from the handling cell traffic; and
means for adjusting at least one of on-loading or off-loading policy based on the actual energy cost.

36. The apparatus of any one of claims 31 to 35, further comprising:
means for receiving a report from the neighboring radio access network node or the operations and maintenance function of at least one of actual energy saved or actual energy cost from the handling cell traffic; and
means for adjusting at least one of on-loading or off-loading policy based on the report.

37. A computer program product encoding instructions for performing the method according to any of claims 13-24.

38. A non-transitory computer-readable medium encoded with instructions that, when executed in hardware, perform the method according to any of claims 13-24.
